(19) United States
(12) Patent Application Publication
(10) Pub. No.: US 2017/0228689 A1
(43) Pub. Date: Aug. 10, 2017

(54) A MANAGEMENT PLATFORM FOR A DISTRIBUTION NETWORK

(71) Applicant: ASSET OWL PTY LTD., Melbourne, Victoria (AU)

(72) Inventors: Tim Brady, Melbourne, Victoria (AU); Giuseppe Di Franco, Melbourne, Victoria (AU)

(21) Appl. No.: 15/514,664

(22) PCT Filed: Sep. 28, 2015
(86) PCT No.: PCT/AU2015/050579

§ 371 Date: Mar. 27, 2017

(30) Foreign Application Priority Data
Sep. 26, 2014 (AU) 2014903851

(51) Int. Cl. G06Q 10/08; G06T 11/60

(52) U.S. Cl. CPC G06Q 10/087; G06T 11/60

(57) ABSTRACT

A management platform for a distribution network, comprising: an information storage medium having stored therein asset information descriptive of assets associated with constituents of the distribution network; a network interface; and a processor operatively associated with the information storage medium and the network interface, and operable to provide output information corresponding to the asset information via the network interface.

### FIELD OF INVENTION

The present invention relates to a management platform, more particularly to a management platform for a distribution network.

### BACKGROUND ART

Management of multiple stores in a distribution network can be a challenging task. Generally, a conventional central management function would be implemented to manage each store with regard to, for example, policies, standards, initiatives and assets. Because operation of the conventional central management function requires accurate, comprehensive, updated information of the stores, a significant amount of resources (e.g. labour and financial resources) may be needed to obtain this information. Processing information obtained may involve performance of certain tasks by store staff and also dispatch of support staff from a management centre. Depending on circumstances, these processes may even involve employing contracted staff.

Nevertheless, information thus collected may still be inaccurate due to potential inconsistencies in methods and standards used in obtaining information that are adopted by the staff. Furthermore, the extent of inaccuracy of information thus obtained and the amount of resources required for obtaining the information are generally proportional to the number and the geographical distribution of stores in the distribution network. Accordingly, larger distribution networks are generally more susceptible to such problems. Such inefficiencies involved in obtaining information may also have other adverse impacts, including impacts on the time required to make a decision and to enforce a policy change, resulting in low efficiency and productivity.

The subject matter claimed herein is not limited to embodiments that solve any disadvantages or that operate only in environments such as those described above. Rather, this background is only provided to illustrate one exemplary technology area where some embodiments described herein may be practice.

### SUMMARY OF INVENTION

The present invention relates to a management platform for a distribution network comprising: an information storage medium having stored therein asset information descriptive of assets associated with constituents of the distribution network; a network interface; and a processor operatively associated with the information storage medium and the network interface, and operable to provide output information corresponding to the asset information via the network interface. The constituents may comprise, for example, a store, a third-party store, a warehouse, or a third-party warehouse. As used herein, these terms may be used interchangeably to refer to the constituents.

The management platform may be implemented in the form of a cloud platform or any other suitable server-client arrangement or client-client arrangement for management of a distribution network. The distribution network may be a retail distribution network or a wholesale distribution network. The assets may be those associated with a warehouse, a supermarket, a convenience store or a department store. However, application of the management platform is not so limited.

It will become apparent from the description below that the management platform of the present invention is suitable for asset management of any type of distribution network.

The output information may be suitable for panoramic rendering, a result of which may be a panoramic presentation of the assets of one of the constituents of the distribution network. The output information may also be suitable for presentation in other forms, such as planograms.

In certain embodiments, the output information comprises panoramic images obtained from images of the asset information. The panoramic images may be obtained by:
obtaining raw images of the asset information;
confirming viability of the raw images of the asset information;
converting the raw images into a predetermined format;
batch stitching the converted raw images into the panoramic image; and
confirming the viability of the panoramic image.

The panoramic images obtained may be geolocated on a map of a respective constituent of said distribution network. The geolocation may be based on pose estimation via a 2d LIDAR scan, absolute relevant position based on a RF positioning system, or position based on the photographer's input and assignment of the panorama positioning manually during capture.

In a particular arrangement, the information storage medium has further stored therein layout information descriptive of layouts of the constituents, the output information further corresponding to the layout information. In such an arrangement, a result of panoramic rendering of the output information may be a panoramic representation of the asset of one of the constituents in context of the layout of said one of the constituents. The layout information may be obtained using computer-aided design (CAD) techniques or any other suitable techniques, such as geographic information systems (GIS) software. Advantageously, the layout information, for example a floor plan, may be copied and worked on off-line to modify the layout and make design changes.

In an exemplary scenario, the assets may be merchandise, fixtures and fittings, and the layout may be a store layout. In another exemplary scenario, the assets may be tools and hardware and the layout may be a warehouse layout. The layout may, for example, take the form of one of a floor layout, a wiring layout, a plumbing layout, and a combination thereof. Of course, the layout may also take on any other suitable form, depending on applications.

The processor may be further operable to update the asset information stored in the information storage medium according to update information received by the processor. Such update information may be received by the processor via the network interface, and may be descriptive of information for updating the asset information. In one particular application, the update information may be received from a client device (e.g. a smartphone or tablet). The update information may include, for example, image information. The image information may be representative of an image of at least one of the assets, and may be generated by an image capture module. It is envisaged that the processor may be further operable to update any information (e.g. the layout information) stored in the information storage medium according to the update information received by the processor.

The update information may include model information, which may be representative of a three-dimensional (3D) model of one of the assets. Such model information may be suitable for rendering in a 3D manner.

Such that the output information is compatible with a computing device (e.g. the client device), the output information may be generated from the asset information according to compatibility information descriptive of compatibility requirements of the computing device to which the output information is to be provided. Such compatibility information may be descriptive of requirements in respect of, for example, screen resolution, processor capacity and network interface capacity. Accordingly, depending on the compatibility requirements, the output information may be different from, but still correspond to, the asset information. There may be circumstances where the output information is identical to the asset information.

The information storage medium may have further stored therein geospatial identifier information in relation to the asset information, the geospatial identifier information being descriptive of a plurality of geospatial identifiers corresponding to the assets, respectively. Each of the geospatial identifiers may be an identifier associated with spatial information. Such identifiers may be a computer-readable medium, such as a one-dimensional (1D) barcode, a two-dimensional (2D) barcode, or a near-field communication (NFC) tag. The spatial information may be information capable of indicating a location. In one configuration, the spatial information comprises Cartesian coordinates. In another implementation, the spatial information comprises global positioning system (GPS) coordinates. Depending on applications, the output information may further correspond to the geospatial identifier information.

The identifiers may be associated with geospatial information derived from a floor plan. For example, the floor plan of a constituent of a distribution network may be divided into segments or bays which include an identifier, such as a barcode, etc.

An employee of the constituent may have a reader that is manually used to read the barcode and thereby derive the respective geospatial information.

Other than assets, the management platform may also be used for managing other aspects of the constituents of the distribution network, including, for example, policy at each store.

It is envisioned that users of the platform may include, but are not limited to, a retailer or a supplier belonging to a distribution network. The management platform may be configured to provide additional functions, such as access to and storage of data as well as being capable of report generation based on data associated with the management platform.

Many of the above components and features of the invention may be provided by a store view module of the system according to the invention. For example, the store view module may advantageously provide for:
Private virtual tour of each store in the distribution network, including: store exterior, interior and back-of-house;
Professionally shot, high dynamic range panoramic images, captured at high resolution with zoom capability;
Information from all existing functional teams/systems (SAP, Oracle, JD Edwards, CAD etc.) can be converted if necessary and imported onto the storage medium (e.g. the system ‘cloud’);
Panoramic images dynamically loaded with information specific to each image;
Geospatial referencing—Geospatially linking all store documentation to a specific location on a store floor-plan;
CAD and GIS system which includes: the browser by providing ability to copy floor-plans and work ‘offline’ on proposed floor-plan and design changes; and each floor-plan is broken down by department, aisle and bay with relevant information geospatially referenced against it;
Up-to-the-minute visual record of the network, providing the ability to upload new images and information in real time;
Powerful search functionality such as: store, category, bay level (plan-o-gram; bay elevation guides) and activity (Information Requests, Projects).

The system may further comprise an information request module that enables requests for information to be communicated throughout the distribution network. For example, requests may advantageously be made consistently and immediately to team members or external third party suppliers. Request may be tailored to specific user needs. For example, requests may include:
Questions requiring text, multiple choice format, measurements, Yes/No/Not Applicable and also allows requests for images/video of the environment;
Ability to include all stores, or select stores only in the request;
Recommended start time and completion date;
Budgeted time to complete request;
Equipment required;
Participation—nominates whether the request will be completed by store team members or by a nominated and approved third party supplier(s)—if a supplier to perform request, suppliers can be set up on a ‘one-off’ temporary account;
Budgeted cost;
Ability to set up automated reminders to participants in their store's Operations Planner; and
Ability to upload any file (document, image, video)

The information request module may facilitate population of an information request with data and the ability to build the information request over time. It may be integrated with an operations planner module. For example, all planned activity may refer first to each store's store calendar and the system identifying any clashes to prevent multiple activities running concurrently. This may advantageously lead to reduced customer disruption.

At the store level, the system of the invention advantageously allows store team members or third party suppliers to receive and gather requests for information and upload to the system on a step by step basis, thereby becoming an operational tool for execution. An advantageous outcome from using the system of the invention on mobile devices as an operational tool, is that it captures the actual time taken to complete requests for information providing valuable information to the business, such as actual time versus budgeted time for a request, quantifiable data on the actual number of the operations team member hours being utilised for support function activities if store team members are required to complete the request, benchmark information across users/stores, and the ability to upload images and stitch together multiple images in real time, maintaining the accuracy of the store environment.

The system additionally allows requests for information to be targeted to head office staff, who will answer the request virtually. The invention presents a Virtual Tour of each asset that is marked for an information request, while gathering responses to its questions. This presents a considerable labour cost saving and opportunity cost saving at a store level. Questions that cannot be answered virtually can be re-targeted for in-store completion.

Dashboard reporting of all active requests enables tasks to be monitored and managed in real time, indicating the stage of completion of each store request. Where multiple stores are requested to provide information the overall status of completion of the request across all stores is illustrated. Reporting may be provided on a store by store basis and collated for all participants in the request. Advantageously, information can be exported into Excel and all images exported in PDF. At an individual store level, a report may indicate the stage of completion. A report may indicate which individual team member or supplier representative is performing the request and the system may provide the ability to communicate directly with them. If required, the system may also provide for resetting the request

The information request module may be used by team members and third party suppliers to gather information at a store(s)/network level for a range of purposes, including but not limited to: pre-existing conditions of the store environment; store mapping data and updates; asset audits; rack inspections; safety compliance audits; energy and lighting audits; and equipment inspections.

The system of the invention may further comprise a projects management module that enables projects to be communicated throughout the distribution network.

Projects may advantageously be easily generated and tailored to each projects specific requirements. For example, the project management module may provide for:
Project Scope;
Ability to include all stores, or select stores participating in the Project;
Ability to establish stages within each Project;
Task management per stage;
Establishing interdependent stages;
Recommended start time and completion date;
Budgeted time;
Budgeted cost;
Equipment required;
Participation—nominates whether the Project will be completed by store team members or by a nominated and approved third party supplier(s);
If pre-works are required, establishing what that is, by whom and when it needs to be completed;
Ability to set up automated reminders for participants in the project in their stores Operations Planner;
Ability to add attachments, such as Safe Work Method Statements (SWMS's) for proposed works to be performed, Capex approvals, PO's, Information Requests relevant to the Project are imported from the Information Request module, Bay Layout Guidelines, Revised CAD drawings; and
Proposed Schedule for Project roll-out, integrated with Operations Planner module, all planned activity refers first to each store's store calendar, calls out ‘clash detection’ to prevent multiple activities (Information Request & Projects) running concurrently, leading to reduced customer disruption.

At a store level, the projects management module advantageously allows store team members or third party suppliers to receive and execute projects on a step by step basis, thereby becoming an operational tool for execution.

In a similar vein to the information request module, the projects management module may provide an operational tool for managing projects by capturing the actual time taken to complete projects, providing valuable information to the business, such as: actual time versus budget time and quantifiable data on the actual number of operations team member hours being utilised for support function activities. It may provide a benchmark tool for use across users/stores.

It may further provide the ability to upload images and stitch together multiple images in real time.

Image capture generally forms the final stage of all projects, serving multiple purposes. It acts as a visual record of the standard of project execution which is uploaded to the Project Owner for the specific project for final sign-off/acceptance. If approved for sign-off, the image is then authorised for uploading to the store view module as a “Still” and becomes the real time, image of the store environment.

If the project is performed by an external third party supplier, the image may also act as a Certificate of Completion, which upon the Project Owner's sign-off, triggers creation of supplier invoice.

The projects management module may facilitate dashboard reporting of all active projects. This may enable each project to be monitored and managed in real time, indicating the stage of completion of each store project. Where multiple stores are included in a project, the overall status of each project across all stores is illustrated.

At an individual store level, the stage of completion of each store project is indicated, as is which individual team member or supplier representative is executing the project. The module may facilitate the ability to communicate directly with the relevant party of parties.

A user may geolocate an image taken when signing off on a project at a store. This is then the image that is represented as the newest one of the store view module assigned to the particular bay location. This facilitates accurate and up to date information being maintained in the database. In particular, after the user takes a photograph, they are served the latest floorplan of the store and can search the bay they are at or just select it from the floorplan. They may review the name and location data of the bay to ensure it is the correct bay to assign the photograph to, and then confirm the photograph geolocation to that bay.

The system may further provide an operations planner module. This may be used as a store level operational tool. For example, it may identify all store based activity which is planned, underway and has occurred in each store location in the format of a calendar, by day, week or month. It may make it possible to plan, allocate existing store resources and, if necessary, arrange additional resources to complete the scheduled activity (Information Requests/Projects) in the required timeframe.

Advantageously, the operations planner module is integrated with the information requests modules and the projects management module. All planned activity refers first to each store's store calendar and the operations planner module preferably calls out ‘clash detection’ to prevent multiple activities running concurrently. The module lists the resources and equipment requirements for each activity.

A summary of each activity is preferably provided, with a real-time indicator of completeness for each activity. Search functionality by store, date range and activity (e.g. Information Requests/Projects) is also advantageously provided. The operations planner module further advantageously integrates with other calendar systems, e.g. Office 365.

Each store's specific information is listed in the operations module, for example: store name/number, store type, store size, store area (sqm2), department/category area (sqm2), carpark bays, key contact details, etc.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF ACCOMPANYING DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 illustrates a management platform hosted by a server device in communication with two client devices via a network, according to an embodiment of the present invention.

FIG. 2 illustrates an exemplary scenario involving a plurality of client devices in communication via a security function with a server device on which a management platform of the present invention is hosted.

FIG. 3 illustrates a mapping process used by the system of an embodiment of the invention.

FIG. 4 illustrates a panorama image processing and geolocation flow chart showing how simple raw images are converted into panoramas and geolocated against a floor plan.

### DETAILED DESCRIPTION OF THE PREFERRED EMBODIMENT

The present invention provides a management platform for a distribution network. Hereinafter, this specification will describe the present invention according to the preferred embodiment. It is to be understood that limiting the description to the preferred embodiment of the invention is merely to facilitate discussion of the present invention and it is envisioned that alternative options may be appropriate without departing from the scope of the appended claims.

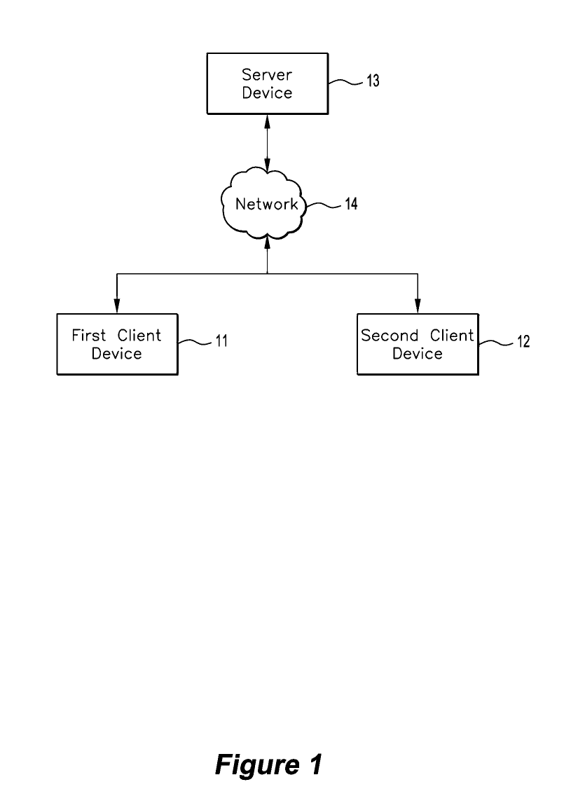

In the preferred embodiment as shown in FIG. 1, the management platform is hosted by a server device 13 in communication with a first client device 11 and a second client device 12 via a network 14. Each of the devices 11-13 includes a network interface (not shown) in communication with the network 14, and a processor (not shown) operatively associated with the network interface. The server device 13 further includes an information storage medium (not shown) operatively associated with the processor of the server device 13, and having stored therein asset information representative of assets of constituents of a distribution network and layout information representative of layouts (i.e. store layouts) of the constituents. In this embodiment, the layouts are in the form of Cartesian planes. The assets of each of the constituents are associated with respective geospatial identifiers, which, in this embodiment, are barcodes including geospatial location information in the form of coordinates of the Cartesian plane of the constituent.

For clarification, operations described below as being performed by each of the devices 11-13 are operations performed by the processor of the device 11-13 in association with relevant components of the device 11-13.

In this embodiment, the first client device 11 is a computing device (e.g. a smartphone or tablet device) including an image capture module for capturing images. The first client device 11 is operable to capture images of the assets so as to generate image information, and to provide to the server device 13 via the network 14 update information including the generated image information. The server device 13 is operable to update the asset information in the information storage medium according to the update information received by the server device 13. Such arrangement may facilitate uploading of images of the assets by, for example, staff associated with the constituents.

The asset information comprises a plurality of entries corresponding to the assets, respectively. Each of the entries is associated with image information representative of at least one image of the corresponding asset, and geospatial identifier information representative of the geospatial location information of the geospatial identifier of the corresponding asset. The provision of geospatial location information not only provides an additional layer of important information to users of the system, but also facilitates production of “heat maps”. For example, multiple heat maps may be overlaid onto the floor plan to show activity, such as information requests and project (discussed hereafter), sales for a location, department or store, and so on. Importantly, the provision of geospatial location information advantageously makes available key sales metrics for locations (i.e. within stores or constituents), departments and so on.

The server device 13 is further operable to provide via the network interface 14 output information corresponding to the asset information and the layout information in the information storage medium. For example, in response to a request for asset information of one of the constituents from the second client device 12, the server device 13 is operable to provide, to the second client device 12 via the network 14, the output information based on the image information and the geospatial identifier information of the assets of said one of the constituents together with the layout information of said one of the constituents.

In this embodiment, the output information is generated by the server device 13 from the asset information and the layout information according to compatibility information descriptive of compatibility requirements of the second client device 12, thereby ensuring compatibility of the output information with the second client device 12.

It is worth noting that, in other embodiments, the output information may be otherwise generated by, for example, another computing device based on the asset information in the information storage medium. Moreover, in other exemplary embodiments, the asset information and the layout information may be provided directly to the second client device 12 without processing by the server device 13. That is, the output information is identical to a combination of the asset information and the layout information.

By virtue of the image information and the geospatial identifier information in the asset information and the layout information from which the output information is generated, the second client device 12 is operable to render a virtual tour based on the images and the geospatial identifiers of the assets in relation to the layout of said one of the constituents according to the output information received by the second client device 12. Specifically, for each of the assets of said one of the constituents, the at least one image of the asset is rendered in the virtual tour according to the coordinates of the corresponding geospatial identifier based on the Cartesian plane of the layout corresponding to said one of the constituents.

Because the output information in this embodiment is suitable for panoramic rendering, the virtual tour thus rendered includes at least one panoramic representation of the assets with respect to the layout of said one of the constituents. The virtual tour may also be interactive, enabling a user of the second client device 12 to navigate through the virtual tour.

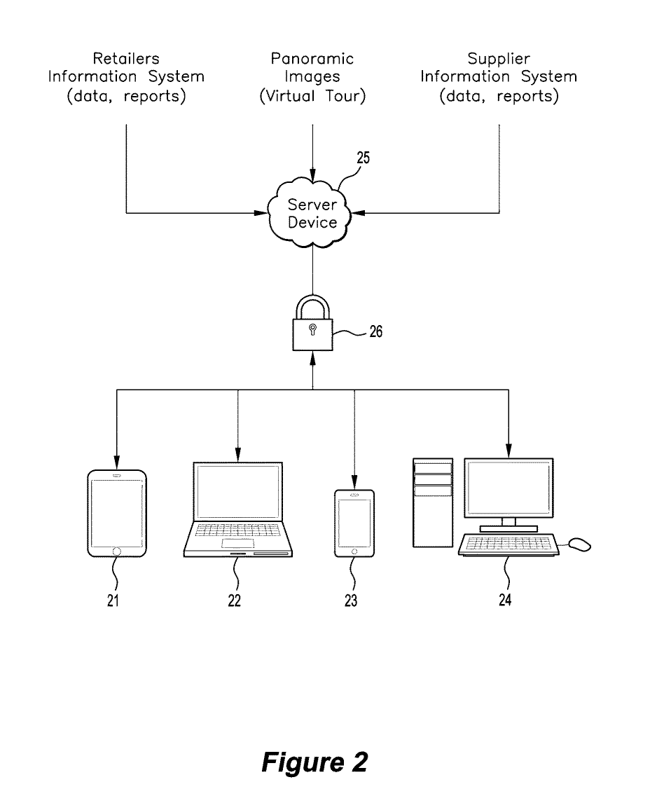

Shown in FIG. 2 is an exemplary scenario in which four client devices 21-24 are in communication with a server device 25 via a network (not shown) through a security function 26. The server device 25 is configured to host the management platform of the preferred embodiment. The security function is operable to provide any security-related function, such as user authentication, firewall, routing policy and access control. The client devices 21-24 are a tablet device, a portable computer device, a smartphone device and a desktop computer device, respectively.

In this scenario, the distribution network involves retailers and suppliers. The server device 25 in this scenario has stored therein information relating to the retailers and suppliers. Such information (i.e. data) includes asset information and layout information in respect of each of the retailers and suppliers. The server device 25 is operable to generate a report based on the information stored therein. For example, a report generated by the server device 25 may present information of inventory associated with a retailer in the forms of a planogram and a table.

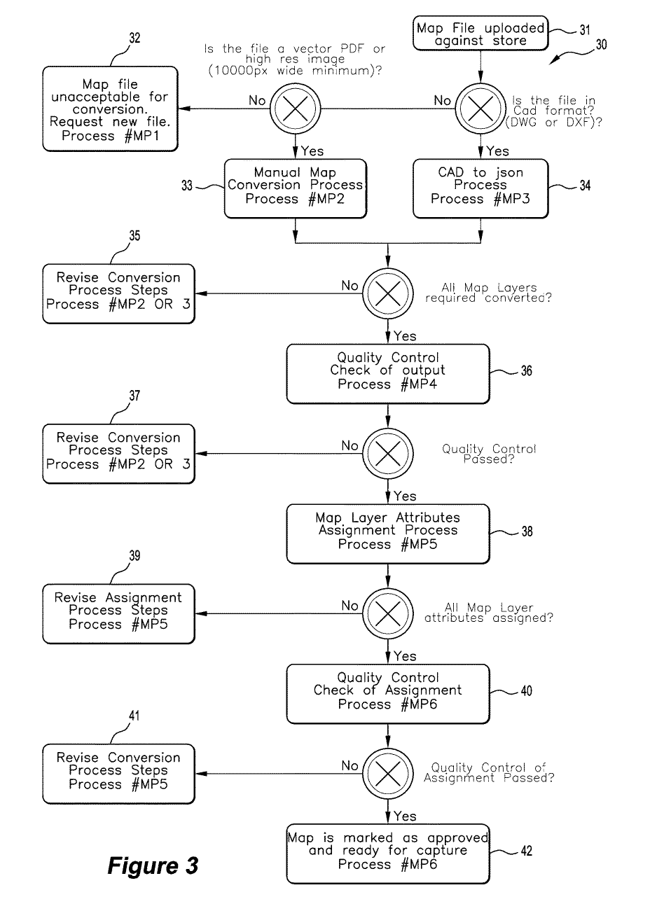

Referring to FIG. 3, a mapping process 30 is illustrated. The mapping process 30 illustrates how a CAD or Vector PDF map is converted into a map usable by the system of the invention and accessible via any user device. The objective of the map conversion process is to take a map that is in a proprietary cad format, such as DWG or DXF, or a non-geospatial format, such as a flat vector PDF, and convert it into a shapefile format that can be more easily interpreted by any GIS system. Once the initial shapefile map is made, it is possible to begin to assign attributes to bays and other items of the floorplan that a retailer requires, such as merchandise departments, locations of particular assets etc.

Initially, a map file is uploaded against a store 31. If the file is not in CAD format and is not a vector PDF or high res image, the map file is unacceptable for conversion and a new file request is processed 32. Specifically, if a map does not meet the minimum requirements for conversion by either being a DWG/DXF file or being a flat file such as a vector pdf or an image of at least 10000 pix wide, then it cannot be converted by the mapping process 30 of the invention without compromising the final output quality of map accuracy. If a user, such as retailer, does not have any maps of the store above this resolution, or any accurate map, then there are 2 options available: a map may be built from scratch in CAD or from a point cloud map converted to CAD and refined; or the point cloud map can be provided by the system.

If the file is a vector PDF or high res image, a manual map conversion process 33 is carried out. The manual map conversion process 33 involves the use of a GIS software suite to produce a new vector shapefile map by drawing polygons over the top of the flat map that is used as a guide in the conversion. This process can be highly accurate if the flat map provided is of high resolution.

If the file is in CAD format, a Cad to json process 34 is carried out. The CAD to json process 34 involves using a software package to automatically convert each layer of the cad file (points, polyline, polygons, multipatch, labels) into its own shape file. These shape files are then merged to produce the final shapefile map with all boundary walls, bays, assets and other areas the retailer requires. During the conversion process there is the potential for artifacts in the shapefile to be poorly or inaccurately converted. This is a rare occurrence, but sometimes may require the user to clean the artifacts up by deleting or rearranging shapes on the map.

If all map layers are not successfully converted, it may be necessary to revise the conversion process 35. This may involve the steps outlined for the manual map conversion process 33 or Cad2Shape process 34 described above. If the map layers are successfully converted, a quality control check of output 36 is carried out.

The quality control process 36 is completed by someone other than the user who converted the initial map and is to confirm at least the following requirements:
All bays are present and there are no abnormally empty areas on the map;
All Boundary walls are present and there are no abnormally shaped walls;
There are no visible artifacts on the map present; and
If the map was manually converted, that all vector lines that should correspond with a 0 or 90 degree heading do so unless they are clearly diagonal/uniquely shaped objects.

If the quality control process 36 indicates that quality is unsatisfactory, it may be necessary to again revise the conversion process 37. If the quality is confirmed as satisfactory, a map assignment process 38 is carried out.

The map assignment process 38 involves a user assigning attribute data to shapes, such as bays and assets, to give them more context on the map. An example of this may be that client A requires each bay to have a bay number, name and description. Documents may be sourced that contain this information and used as a guide on an intuitive interface to assign that data to the map.

If all map layer attributes are not assigned, the map assignment process is revised 39. If all map layer attributes are assigned a quality control check of the assignment 40 is carried out.

The quality control process 40 is conducted by someone other than the user who assigned data to the map and is to confirm at least the following:
That each bay has the required attributes assigned against it and is missing attributes only if they are not locatable in the documents provided; and
Based on a random spot check on 10% of the data, the results match the provided guides. If any bays in the 10% fail the testing the map is put back to the assignment team to redo 41.

If the quality control of attributes is passed, the map is marked as approved and ready for capture 42.

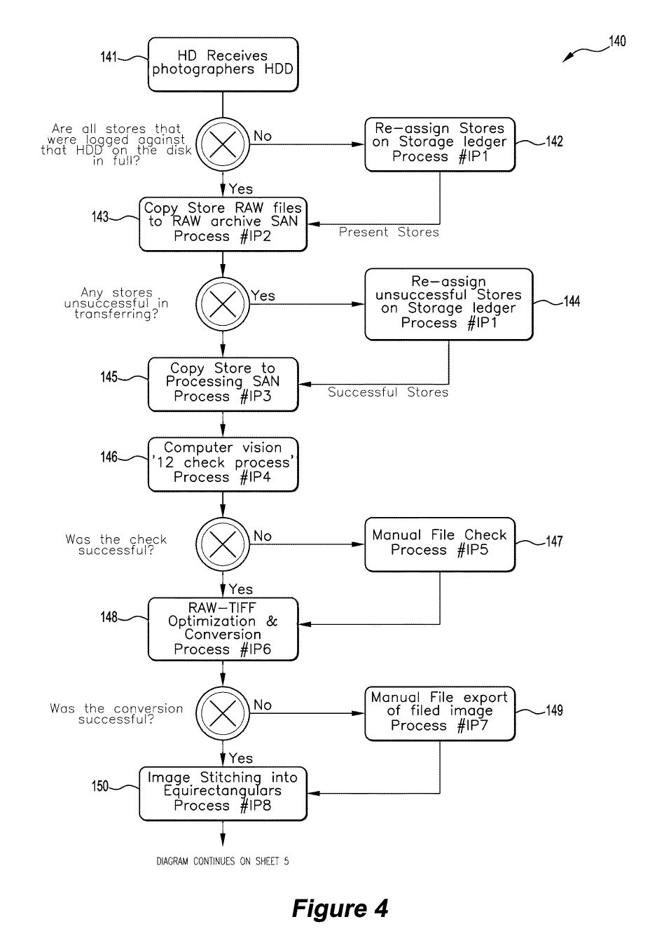

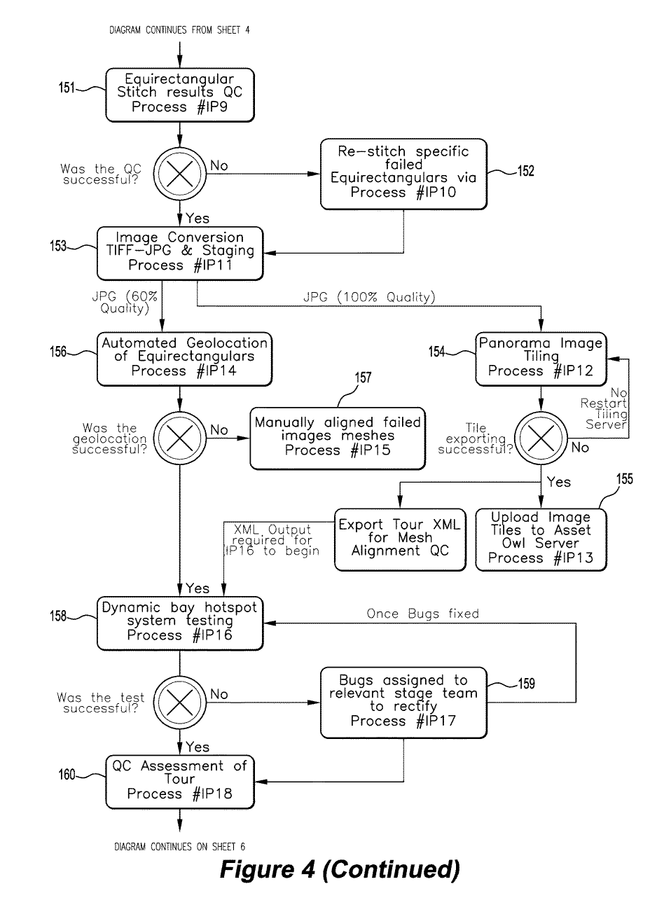

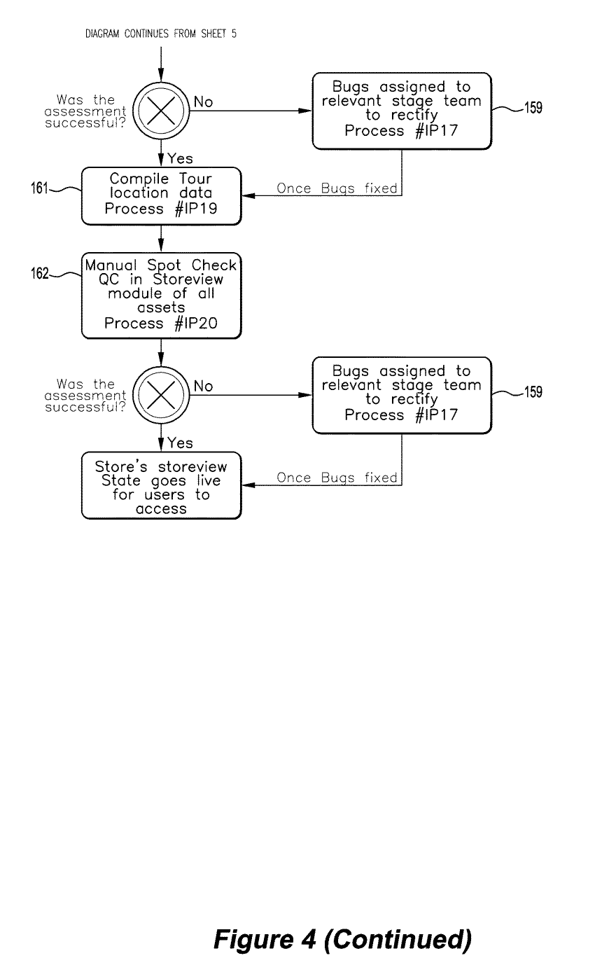

Referring to FIG. 4, a flowchart is provided that illustrates a process 140 for panorama image processing and geolocation. This shows how simple raw images are converted into panoramas and geolocated against a floor plan according to an embodiment of the invention, as discussed below. Thus, the objectives of the panorama image process 140 is to take raw images from the camera and turn them into high resolution panoramas, geospatially reference these panoramas against a store floorplan and finally generate hotspots dynamically against each bay or point of interest to attach items.

When a photographer sends a hard drive to HQ 141 he also logs on the system what stores HQ can expect to find on the HD. If HQ receives the hard drive and finds that stores are missing compared with what is expected from the system, the photographer is asked to submit the omitted images to HQ 142. This ensures the photographer does not delete the images for the store from his hard drive prior to delivery to HQ.

In the case where images for a store are on the hard drive, but the folder or files are corrupted and fail to copy to the HQ storage area network (SAN), again the images are requested from the photographer.

If the hard drive received includes all required images, the images are copied onto a raw archive SAN 143. This unit stores all raw files which are never directly interfaced with during processing. Once images for stores have been successfully copied to the raw SAN they are logged as safely transferred to HQ so the photographer knows they can now delete those stores on their end. No processing is carried out directly from the raw archive SAN. If images of any store are not successfully transferred the unsuccessful stores are reassigned to the photographer 144.

The store, once copied to the HQ raw SAN successfully, should then be copied from this source to a processing SAN 145, which will store and handle files during processing stages. A store cannot begin any processing until it is copied over to this source.

A 12 check process 146 is carried out to ensure complete sets of 12 images are provided that will make a panorama. This involves converting each raw image into a 1200×1800 px jpg 7 and manually checking the starting panorama, the middle of the set and the last panorama in the set to see if there are any major file issues. Once this is resolved, the image set is put through a pt gui batch stitch to produce a 1800 px wide panorama which is then put into a contact sheet in photoshop with the output contact sheet being inspected by a processing team member who scrolls through the panorama to ensure the images have stitched correctly.

If the contact sheet inspection finds an issue in the file sortment the processor then goes through the files that were affected at a single image level (not panorama) and finds the source of the problem 147. Once resolved, the processor carries out the 12 check process 146 again to ensure a perfect set of images is provided.

Raw to tiff conversion 148 is then carried out using Adobe Lightroom or Capture One. This involves the processor applying a global setting to all images for sharpness, chromatic aberration correction and then applying white balance, tint, brightness, shadow correction, contrast, clarity, vibrancy and saturation for specific areas of the store (e.g. Outdoor will have completely different settings to back of house due to the different lighting source). Once settings are applied images are exported in bulk as 16 bit sRGB tiffs. To speed up the export process the software may have 3-5 simultaneous exports of image sets happening at once.

Sometimes during file export from Lightroom there may be failure due to lack of system memory, destination drive space or other reasons. If this happens, the processor assesses the cause and makes adjustments to ram/disk space and then deletes all exported images and begins again 149. As there is a real chance for image sets to go missing, given more than one export of the same image set is proceeding at one time, the processor continues exporting from where they left off unless the software is aware that files failed to save and it is a small group of images (under 10% of store total).

The stitching process 150 begins with the processor importing the total store image set into the batch builder of pt gui, assigning the correct custom lens/camera profile to the set and generating the stitch files. Once generated, the stitch process is initiated with the batch stitcher tool. As the 16 bit tiff full resolution images are being exported into the destination folder a separate image process takes these images and resizes them to the test size resolution suitable for the following stage, described below, and storing the outputs in a separate folder ready for the test.

The test size should be 70% of the width of the monitor the tester is using for a good immersive overview of the image. As the standard monitor size recommended is 3440×1440 the output test image should be 2400 px wide and be in jpg format, 50% quality.

The testing of the stitch results 151 is conducted on a large monitor and involves the processor clicking through each image in full screen mode, inspecting the final stitch results for the following abnormalities:
stitching errors such as misalignment of horizontal or vertical parts of the image;
fuzziness due to image softness or HDR misalignment; and
completely incorrect image sets combined.

Any images that fail testing 151 are manually corrected 152 to pass the standards test 151 and are exported. The correction process depends on the abnormality. Any images that cannot be manually corrected and are complete fails should be added to the list of images deleted against the store.

Once all panoramas have been stitched 150 and approved 151, 152 the 16 bit tiffs are then converted 153 into two separate streams of jpg images, one at 100% quality for tiling and one at 65% for geolocation. The width of the jpgs should also be standardized across all images during both jpg conversions for consistency in file size.

The panorama image tiling process 154 involves putting the high resolution 100% quality jpgs through a tiling service via image tiling software to create multires panorama tile files. All the settings for this process are configured at a high level for the whole processing system. There is the possibility that during processing the process may fail due to ram/disk/iops issues and, therefore, the process restarted and all existing converted panoramas for that store deleted to avoid the risk of missing tiles, causing errors during deployment.

Once all panoramas for a store have been processed, they are zipped and uploaded to the server 155. Once uploaded the server unzips the store in its correct bucket.

A geolocation process 156 is carried out in which panoramas are positioned on a map based on their location registered from either pose estimation via a 2d LIDAR scan, absolute relevant position based on RF positioning system, or position based on the photographer's input and assignment of the panorama positioning manually during capture. Once all nodes have been placed geospatially on the map via this process, connections are then made based on their position on the map and distance to other panoramas. Connections are made between panoramas within line of sight of each other.

In order for panoramas that failed all 3 layers of sensor input data to be aligned with other panoramas, they must be manually aligned with other images via a user interface 157. This is done by representing the store floor plan with all panoramas along with the ability for the user to drag and drop the panorama in the location they estimate to be correct.

A dynamic bay test 158 is conducted to ensure that the geolocation of the hotspots and the assignment of bay level data during the map conversion process is correct. A user compares the result of the document loaded on clicking on the bay in the virtual tour against what document is linked to the bay in the map. The tester assesses a random 10% of bays in the store. If any of the bays assessed are incorrect the store proceeds to a bug fix stage 159. If the bays pass the test, the tour proceeds.

When a store has been assigned to the bug fix stage 159, a tester returns to processes 154 or 156 for the particular store and makes an assessment of the panoramas logged as bugs. The location of the panoramic imagery being misaligned in relation to other images surrounding it is generally the reason for bugs. This may be resolved by toggling between sensor layers of panoramic geolocation or manually adjusting the position until the desired outputs from the panoramas are achieved.

A quality control process 160 is carried out to assess a number of attributes before panoramas are deployed into the live module. If a store fails quality control, it proceeds back to a bug fix stage 159. The attributes may include:
Dynamic navigational hotspots on the virtual tour are correctly linking relevant panoramas with each other (5% of navigational hotspots are to be tested);
Dynamic bay level document hotspots are correctly linking to the 8 pre-assign bays on the map that have been populated with test documents;
The starting panorama of the tour is located in the correct area of the tour as per the client scope for virtual tour delivery.

Once the location information of the panoramas has been verified to be accurate and able to dynamically produce expected results, all panorama locations and orientations and the starting image selection is compiled 161 into a master directory file along with individual files for each panoramas dynamic bay relationship and deployed to the server. Once uploaded, it is compiled with the tour imagery and store map in the store view module.

A user then tests 162 the following attributes to ensure they have deployed and compiled in the store view module correctly for interaction by users (this is the same requirements as the quality control process 160):
Dynamic navigational hotspots on the virtual tour are correctly linking relevant panoramas with each other (5% of navigational hotspots are to be tested)
Dynamic bay level document hotspots are correctly linking to the 8 pre-assign bays on the map that have been populated with test documents.
The starting panorama of the tour is located in the correct area of the tour as per the client scope for virtual tour delivery.

Unless the context requires otherwise or specifically stated to the contrary, integers, steps or elements of the invention recited herein as singular integers, steps or elements clearly encompass both singular and plural forms of the recited integers, steps or elements.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

It will be appreciated that the foregoing description has been given by way of illustrative example of the invention and that all such modifications and variations thereto as would be apparent to persons of skill in the art are deemed to fall within the broad scope and ambit of the invention as herein set forth.

1. A management platform for a distribution network, comprising:
an information storage medium having stored therein asset information descriptive of assets associated with constituents of the distribution network;
a network interface; and
a processor operatively associated with the information storage medium and the network interface, and operable to provide output information comprising panoramic images obtained from images of said asset information via the network interface
wherein said panoramic images are obtained by:
obtaining raw images of said asset information;
confirming viability of said raw images of said asset information;
batch stitching said converted raw images into said panoramic image; and
confirming the viability of said panoramic image;
and wherein the panoramic images obtained are geolocated on a map of a respective constituent of said distribution network.

2-5. (canceled)

6. The management platform as claimed in claim 1, wherein said geolocation is based on pose estimation via a 2d LIDAR scan, absolute relevant position based on a RF positioning system, or position based on the photographer's input and assignment of the panorama positioning manually during capture.

7. The management platform as claimed in claim 1, wherein the information storage medium has further stored therein layout information descriptive of layouts of the constituents, the output information further corresponding to the layout information.

8. The management platform as claimed in claim 1, wherein the processor is further operable to update the asset information stored in the information storage medium according to update information received by the processor.

9. The management platform as claimed in claim 8, wherein the update information includes image information.

10. The management platform as claimed in claim 8, wherein the update information includes model information.

11. The management platform as claimed in claim 1, wherein the processor is operable to generate the output information from the asset information.

12. The management platform as claimed in claim 1, wherein the output information is generated from the asset information according to compatibility information descriptive of compatibility requirements of a computing device to which the output information is to be provided.

13. The management platform as claimed in claim 1 wherein the output information is identical to the asset information.

14. The management platform as claimed in claim 1, wherein the information storage medium has further stored therein geospatial identifier information in relation to the asset information, the geospatial identifier information being descriptive of a plurality of geospatial identifiers corresponding to the assets, respectively.

15. The management platform as claimed in claim 1, additionally comprising an information request module that enables requests for information to be communicated throughout the distribution network.

16. The management platform as claimed in claim 1, additionally comprising a projects management module that enables projects to be communicated throughout the distribution network.

17. The management platform as claimed in claim 1, additionally comprising an operations planner module as a store level operational tool.
